(19) United States
(12) Patent Application Publication
(10) Pub. No.: US 2022/0194426 A1
(43) Pub. Date: Jun. 23, 2022

(54) METHOD AND APPARATUS FOR INCREASING PASSENGER SAFETY BASED ON ACCIDENT/ROAD LINK CORRELATION

(71) Applicant: HERE Global B.V., Eindhoven (NL)

(72) Inventors: Jerome BEAUREPAIRE, Berlin (DE); Leon STENNETH, Chicago, IL (US); Jeremy Michael YOUNG, Chicago, IL (US)

(21) Appl. No.: 17/125,616

(22) Filed: Dec. 17, 2020

(51) Int. Cl. B60W 60/00; B60W 30/08; G06K 9/00; G06F 16/29

(52) U.S. Cl. CPC B60W 60/0016; B60W 30/08; G06K 9/00798; B60W 2540/227; B60W 2540/01; B60W 2540/229; G06F 16/29

(57) ABSTRACT

An approach is provided for minimizing potential vehicle accident impacts based on accident/road link correlation and/or contextual data. The approach, for example, involves processing accident data, topology data, or a combination thereof associated with a road link to determine a potential negative impact on a passenger of a vehicle, the vehicle, or a combination thereof resulting from a potential accident on the road link. The approach also involves determining a seating position within the vehicle for the passenger, a navigation route for the vehicle, an activity for the passenger to perform or avoid while in the vehicle, a dynamic seat repositioning, or a combination thereof based on the potential negative impact. The approach further involves providing the seating position, the navigation route, the activity for the passenger, a dynamic seat repositioning, or a combination thereof as an output.

### BACKGROUND

As more autonomous vehicles, highly-assisted driving (HAD) vehicles, etc. that at least partially drive or otherwise operate themselves without user input are deployed, there are more accidents reported on the news and analyzed in research papers. This, in turn, motivates service providers and vehicle manufacturers to offer compelling features and applications to improve autonomous vehicle safety. As a result, service providers and vehicle manufacturers face significant technical challenges to enhance and/or leverage advanced driver-assistance systems (ADAS) in autonomous or other vehicles in a way that can improve passenger safety against potential accident impacts.

### SOME EXAMPLE EMBODIMENTS

As a result, there is a need for determining potential vehicle accident(s) based on accident/road link correlation and/or real-time contextual data, and then recommending vehicle/passenger action(s) to minimize potential vehicle accident impact(s).

According to one or more example embodiments, a computer-implemented method comprises processing accident data, topology data, or a combination thereof associated with a road link to determine a potential negative impact on a passenger of a vehicle, the vehicle, or a combination thereof resulting from a potential accident on the road link. The method also comprises determining a seating position within the vehicle for the passenger, a navigation route for the vehicle, an activity for the passenger to perform or avoid while in the vehicle, a dynamic seat repositioning, or a combination thereof based on the potential negative impact. The method further comprises providing the seating position, the navigation route, the activity for the passenger, a dynamic seat repositioning, or a combination thereof as an output.

According to another embodiment, an apparatus comprises at least one processor, and at least one memory including computer program code for one or more computer programs, the at least one memory and the computer program code configured to, with the at least one processor, cause, at least in part, the apparatus to process accident data, topology data, or a combination thereof associated with a road link to determine a potential negative impact on a passenger of a vehicle, the vehicle, or a combination thereof resulting from a potential accident on the road link. The apparatus is also caused to determine a seating position within the vehicle for the passenger, a navigation route for the vehicle, an activity for the passenger to perform or avoid while in the vehicle, a dynamic seat repositioning, or a combination thereof based on the potential negative impact. The apparatus is further caused to provide the seating position, the navigation route, the activity for the passenger, a dynamic seat repositioning, or a combination thereof as an output.

According to another embodiment, a non-transitory computer-readable storage medium carries one or more sequences of one or more instructions which, when executed by one or more processors, cause, at least in part, an apparatus to process accident data, topology data, or a combination thereof associated with a road link to determine a potential negative impact on a passenger of a vehicle, the vehicle, or a combination thereof resulting from a potential accident on the road link. The apparatus is also caused to determine a seating position within the vehicle for the passenger, a navigation route for the vehicle, an activity for the passenger to perform or avoid while in the vehicle, a dynamic seat repositioning, or a combination thereof based on the potential negative impact. The apparatus is further caused to provide the seating position, the navigation route, the activity for the passenger, a dynamic seat repositioning, or a combination thereof as an output.

According to another embodiment, an apparatus comprises means for processing accident data, topology data, or a combination thereof associated with a road link to determine a potential negative impact on a passenger of a vehicle, the vehicle, or a combination thereof resulting from a potential accident on the road link. The apparatus also comprises means for determining a seating position within the vehicle for the passenger, a navigation route for the vehicle, an activity for the passenger to perform or avoid while in the vehicle, a dynamic seat repositioning, or a combination thereof based on the potential negative impact. The apparatus further comprises means for providing the seating position, the navigation route, the activity for the passenger, a dynamic seat repositioning, or a combination thereof as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of minimizing potential vehicle accident impact(s) based on accident/road link correlation and/or contextual data, according to one or more example embodiments;

FIG. 2A is a flowchart of an example scenario leveraging an approach for minimizing potential vehicle accident impact(s) based on accident/road link correlation and/or contextual data, according to one or more example embodiments;

FIG. 2B is a diagram illustrating example seat positions during a vehicle trip, according to various embodiments;

FIG. 2C is an example action determination diagram during a vehicle trip to mitigate potential accident impact(s), according to one or more example embodiments;

FIG. 3 is a diagram of the components of a navigation platform, according to one or more example embodiments;

FIG. 4 is a flowchart of a process for minimizing potential vehicle accident impact(s) based on accident/road link correlation and/or contextual data, according to one or more example embodiments;

FIG. 5 is a diagram of an example user interface capable of displaying potential accident(s) and/or negative impact(s) during navigation, according to one or more example embodiments;

FIGS. 6A-6C are diagrams of example user interfaces built in a vehicle and capable of displaying potential accident(s) and/or negative impact(s) during navigation, according to one or more example embodiments;

FIG. 7 is a diagram of an example machine learning data matrix, according to one or more example embodiments;

FIG. 8 is a diagram of a geographic database, according to one or more example embodiments;

FIG. 9 is a diagram of hardware that can be used to implement an embodiment of the invention, according to one or more example embodiments.

FIG. 10 is a diagram of a chip set that can be used to implement an embodiment of the invention, according to one or more example embodiments.

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing output data for an end-to-end seamless experience during an autonomous vehicle trip are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

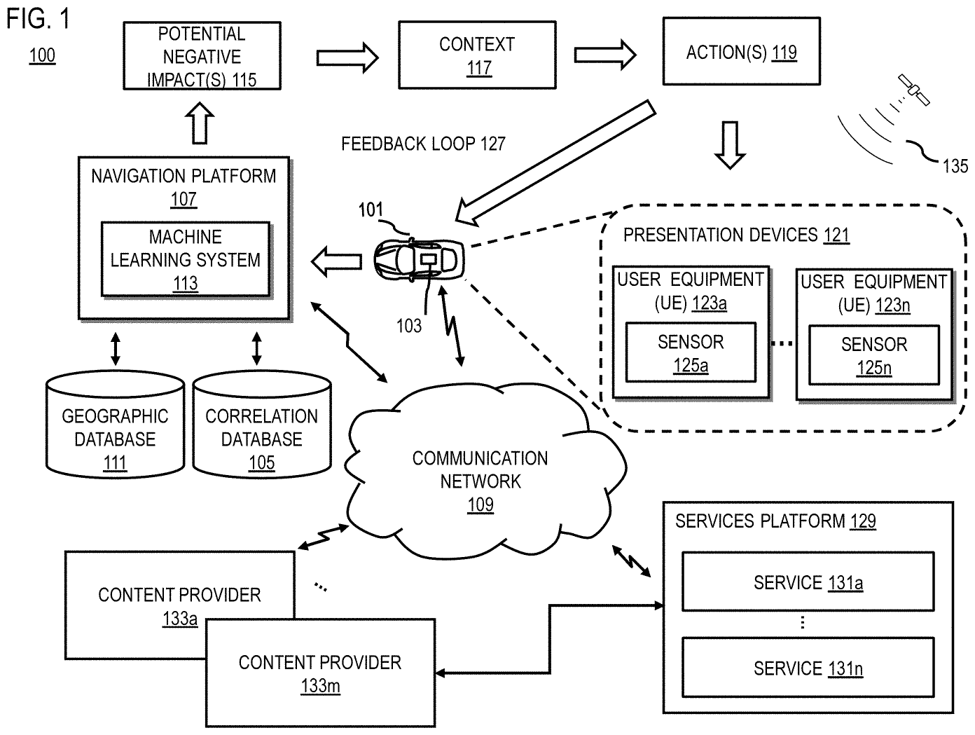

FIG. 1 is a diagram of a system capable of minimizing potential vehicle accident impact(s) based on accident/road link correlation and/or contextual data, according to one or more example embodiments. As autonomous vehicles become more prevalent, more accidents are being reported involving autonomous vehicles, such as rear-end collisions, T-bone collisions, front crashes, rollovers, etc. caused by “unsafe speeds,” “following too closely,” etc. According to a recent study from the Insurance Institute for Highway Safety (IIHS), it is likely that self-driving vehicles might prevent a third of crashes if their systems are set up to drive as human drivers. Although autonomous vehicles can detect their surroundings with sensors, they can still get into crashes.

To address these challenges, the system 100 introduces a capability to determine potential vehicle accident(s) based on accident/road link correlation and/or real-time contextual data, and then recommend vehicle/passenger action(s) to minimize potential vehicle accident impact(s). For example, depending on a potential accident (e.g., a T-bone collision) on a coming road link predicted based on accident/road link correlation and/or real-time contextual data, the system 100 can recommend a vehicle 101 (e.g., an autonomous vehicle) and/or passengers of the vehicle 101 to take action(s) such as moving to safer seats in the vehicle 101, changing the seat angles to face away from a potential collision direction, etc.

In one embodiment, the system 100 can collect accident data via sensors 103 of the vehicle 101 and/or other sources, analyze the accident data for accident/road link correlation data, and store the accident/road link correlation data in a database (e.g., an accident/road link correlation database 105). In addition, the sensors 103 of the vehicle 101 can report location data to a navigation platform 107 via a communication network 109. The navigation platform 107 can generate an optimal route for the vehicle 101 based on map data from a database (e.g., a geographic database 111), and alert/prepare passenger(s), for example, for potential accidents en route based on the accident/road link correlation data. The optimal route can be determined by any navigation routing engine known in the art.

In one embodiment, the navigation platform 107 can include a machine learning system 113 for analyzing accident data and extracting accident pattern data and/or negative impact data associated with road links. The extracted data can be stored in the accident/road link correlation database 105.

Prior to the vehicle 101 reaching a risky road link, the navigation platform 107 can determine potential negative impact(s) 115 (e.g., passenger trauma, vehicle damage(s), etc.) associated with accident(s) that have occurred or otherwise are associated with a coming road link on a current route of the vehicle 101, and identify context 117 (e.g., the current route, a number of passenger(s), operational settings, driving environment, etc.) of the vehicle 101. The navigation platform 107 can then recommend action(s) 119 for passenger(s) and/or the vehicle 101 to take in order to mitigate the potential negative impact(s) 115. For instance, the navigation platform 107 can present such recommendation(s) to the passenger(s) via one or more presentation devices 121 equipped in the vehicle 101. The presentation devices 121 can include multiple user equipment (UE) devices 123a-123n (also collectively referred to as UEs 123) that can provide any number of user interface types (e.g., visual, audio, touch, other sensory, etc.) and respective sensors 125a-125n (also collectively referred as sensors 125) for presenting the action(s) 119 and/or interacting with the passenger(s). By way of example, the action(s) 119 recommended for the passenger(s) can be changing to safer seat(s), suspending eating, or drinking for the coming risky road link to avoid being hit by flying utensils, hot coffee, etc.

As another instance, the navigation platform 107 can transmit the action(s) 119 recommended for the vehicle 101 (such as adjusting operational settings) to the vehicle 101 and/or its advanced driver-assistance system. By way of examples, the operational settings of the vehicle 101 can be set by the navigation platform 107 to reduce a speed, change to a safer lane, adjust seat angle(s), use a harder surface side of a country road instead of the center, etc., so as to mitigate the potential negative impact(s) 115.

As another instance, the navigation platform 107 can transmit action recommendation(s) to first responder(s), medical specialist(s), specialized medical equipment/facilities, etc. to standby and/or to dispatch to the scene depending on the predicted accident impact(s), such as injury/trauma, etc.

As another instance, the navigation platform 107 can transmit action recommendation(s) to vehicle fleet owners, ride-sharing operators, vehicle assistance/repair shops, vehicle insurance companies, passenger health insurance companies, etc. to manage the vehicle 101, to adjust insurance rates, etc., depending on the predicted accident impact(s), such as injury/trauma, damages, etc. and/or the action(s) taken to mitigate the accident impacts.

By way of example, the navigation platform 107 can decide an optimal balance between deploying the system 100 and equipping the vehicle 101 with more advanced/expensive sensors to reach a desired safety level. The more sensors that a vehicle 101 is equipped with, the more expensive the vehicle 101 is like to be; however, if the vehicle 101 generally travels in safe areas, it does not require expensive safety sensors and/or stronger structures. As another example, the navigation platform 107 can decide whether to substitute broken/malfunctioning sensors on the vehicle 101 with a specific map data layer (e.g., a traffic sign map layer), based on the potential negative impact(s) 115 related to coming road link(s) en route.

In one embodiment, the navigation platform 107 can improve the accident impact mitigation process using feedback loops based on, for example, passenger behavior(s) (e.g., from sensor data) and/or feedback data (e.g., from survey data). The arrows in the upper part of FIG. 1 show such a feedback loop 127.

In summary, the system 100 introduces capabilities including but not limited to:
Building an accident/road link correlation database that includes potential negative impacts of potential accident(s) associated with road links through analysis and learning of accident patterns;
Retrieving the potential negative impact(s) 115 related to coming road link(s) en route;
Determining the context 117 (e.g., road link features), passenger context (e.g., user activities, preferences, pre-existing conditions, etc.), vehicle features, vehicle operation context, driving environment, etc.; and
Determining the action(s) 119 recommended for passenger(s) and/or the vehicle 101 to take in order to mitigate the potential negative impact(s) 115, such as a seating position within the vehicle 101 for the passenger(s), a navigation route for the vehicle 101, an activity for the passenger(s) to perform or avoid while in the vehicle 101, a dynamic seat repositioning, etc.

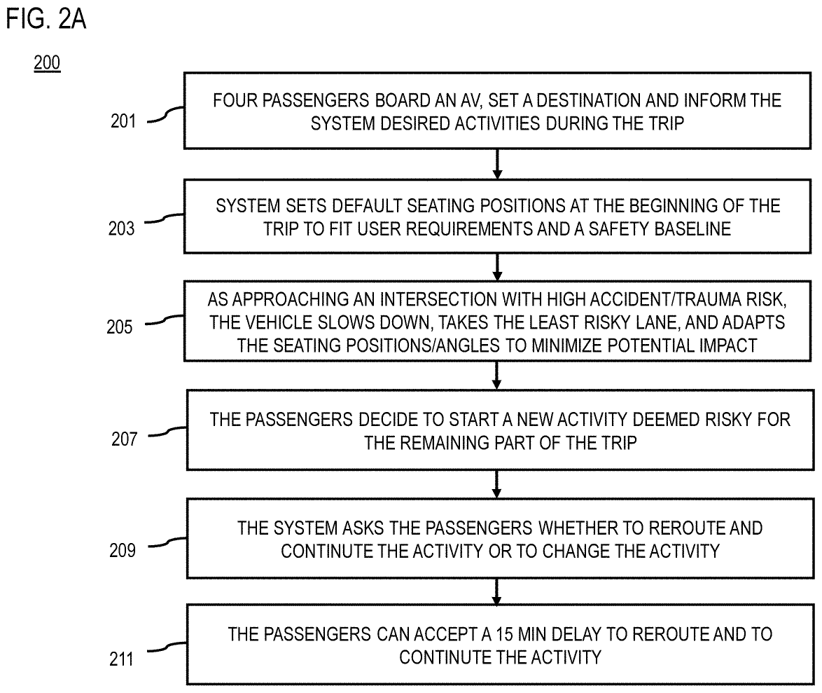

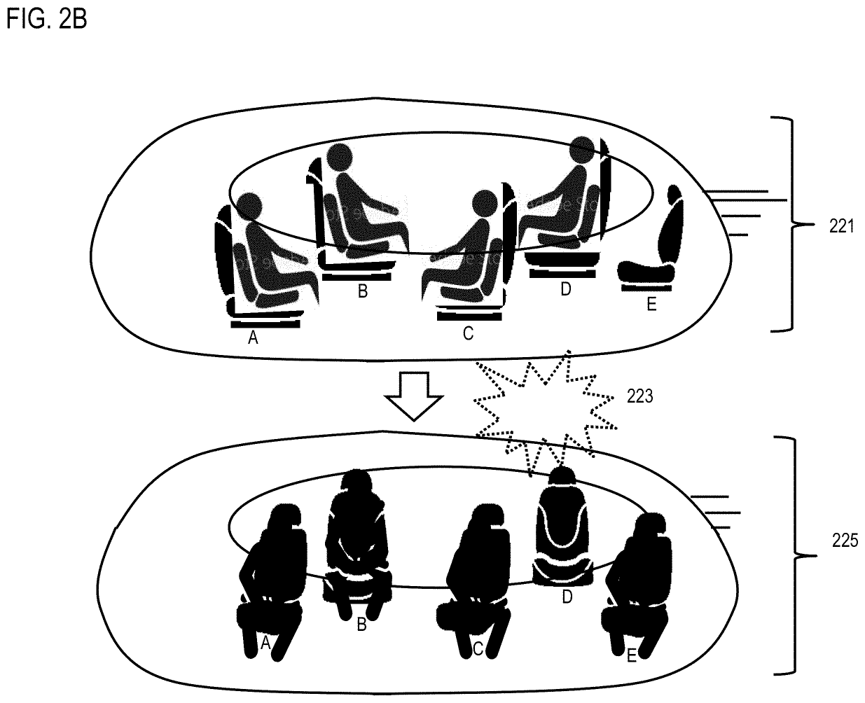

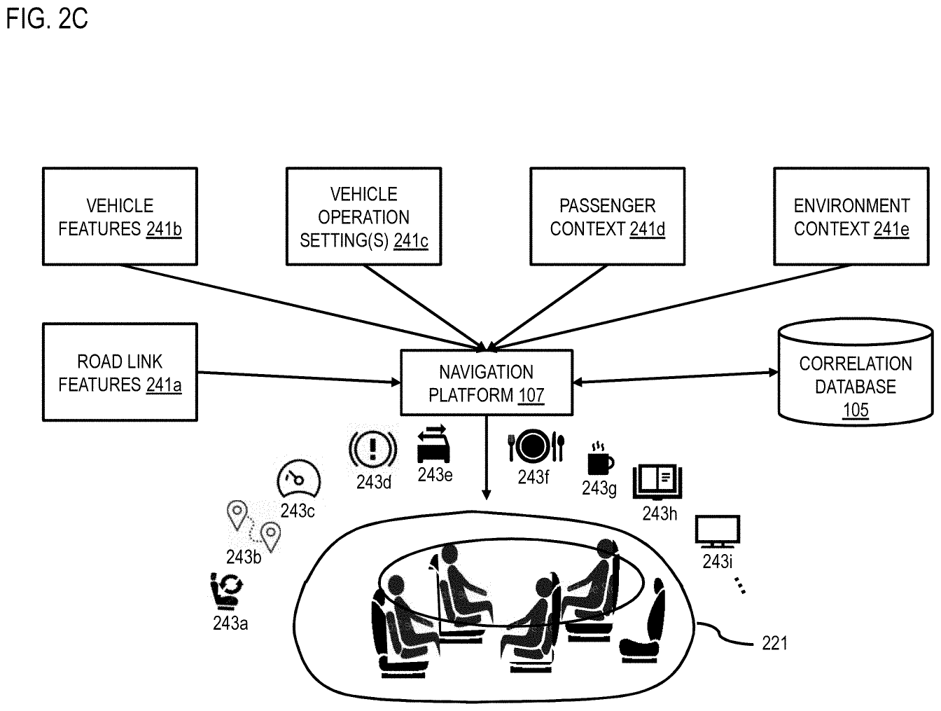

FIG. 2A is a flowchart of an example scenario 200 leveraging an approach for minimizing potential vehicle accident impact(s) based on accident/road link correlation and/or contextual data, according to one or more example embodiments. In step 201, a group of four people board the vehicle 101 (e.g., an autonomous vehicle), set a destination, and inform the system 100 and/or the navigation platform 107 of desired activities during the trip via the communication network 109.

In step 203, the system 100 and/or the navigation platform 107 can set default seating positions at the beginning of the trip to fit the user's desired activities, other requirements, and/or a safety baseline. FIG. 2B is a diagram illustrating example default seating positions during a vehicle trip, according to various embodiments. In the upper scenario 221 of FIG. 2B, the four passengers initially occupy four front seats A-D of the vehicle 101, with Passenger 1 on Seat A reading a book, Passenger 2 on Seat B sleeping, Passenger 3 on Seat C looking at outside views, and Passenger 4 on Seat D drinking a coffee, for example.

As the vehicle 101 approaches a road link (e.g., an intersection) associated with a reasonably high likelihood of the potential negative impact(s) 115 (e.g., passenger trauma, vehicle damage(s), etc.) according to the accident/road link correlation database 105 in step 205, the system 100 and/or the navigation platform 107 can determine the action(s) 119 based on a potential accident 223 (e.g., a T-bone collision), its associated potential negative impact(s) 115, and contextual data depicted in FIG. 2C.

For instance, the system 100 and/or the navigation platform 107 can instruct the passengers to take the action(s) 119, such as change seats, change activities, etc., and/or instruct the vehicle 101 to take the action(s) 119, such as slow down, take the least risky lane, and/or adapt the seating positions and/or angles to minimize the potential negative impact(s) 115. By way of example, in the lower scenario 225 of FIG. 2B, the four passengers change from the four front seats A-D to Seats A-C and E, Seat E towards the left side of the vehicle 101, with Passenger 4 moving to Seat E while Passengers 1-3 stay on the same Seats A-C, for example. In addition, the vehicle 101 and/or the Passengers 1-4 turn the Seats A-E to angle away from the direction of the potential accident 223 (e.g., the right rear side).

Later on in step 207, at least one of the Passengers 1-4 decides to spontaneously start a new activity (e.g., eating on a dining table with forks) in the vehicle 101, which is deemed risky for a coming road link of the route. In step 209, the system 100 and/or the navigation platform 107 can ask Passengers 1-4 whether they prefer adapting the route to the new activity (e.g., a flatter and less busy route) or to change the activity (e.g., suspending eating). In step 211, since Passengers 1-4 are not in a hurry and can accept the 15 minute longer estimated time of arrival, the vehicle 101 can take the new route so that the at least one passenger can perform the new activity.

FIG. 2C is an example action determination diagram during a vehicle trip to mitigate potential accident impact(s), according to one or more example embodiments. In the example of FIG. 2C, the system 100 (e.g., via the navigation platform 107) can determine query sensor data (e.g., from the vehicle 101, UEs 123, the geographic database 111, other sources, etc.) to determine the context 117 associated with road links en route, the vehicle 101, the passenger(s), driving environment, etc. By way of example, the context 117 can include road link feature(s) 241a (e.g., slope, curvature, functional classification, speed limit, signs (e.g., deer crossings), etc.), vehicle feature(s) 241b (e.g., make, model, characteristics, capabilities-speed range, safety rating, working belts, working airbags, etc.), vehicle operation setting(s) 241c (e.g., speed, AV/manual mode, etc.), passenger context 241d (e.g., ages, medical records, weight, height, pre-existing conditions (such as high blood pressure, motion sickness, acrophobia, etc.), the number of passengers, in-vehicle activities, speed preferences, etc.), environment context 241e (e.g., visibility, weather, events, traffic, traffic light status, construction status, etc.), etc.

In one embodiment, the navigation platform 107 can collect real-time sensor data, traffic incident information, and/or context data from one or more other sources such as government/municipality agencies, local or community agencies (e.g., a police department), and/or third-party official/semi-official sources (e.g., a services platform 129, one or more services 131a-131n (collectively referred to as services 131), one or more content providers 133a-133m (collectively referred to as content providers 133), etc.

As shown in FIG. 2C, based on the context 117 and the potential negative impact(s) 115 to be mitigated, the navigation platform 107 can determine the action(s) 119 recommended for passengers/vehicles based on laboratory modeling, survey data (e.g., field data), machine learning, etc. In one embodiment, the navigation platform 107 can deploy the machine learning system 113 to build and train an action machine learning model that can determine the action(s) 119 to be taken by the passenger(s) and/or the vehicle 101 prior to or during the road link, based on the context 117 and the potential negative impact(s) 115 in the scenario 221 described in FIG. 2B. For instance, the context 117 can include real time dynamic vehicle and traffic context extracted from sensor data (e.g., Light Detection And Ranging (LiDAR) and/or radar data from neighboring cars and/or connected services). The extracted data can be stored in the accident/road link correlation database 105.

By way of examples, the action(s) 119 can be seat/angle changing 243a (e.g., the scenario 225 described in FIG. 2B), re-routing 243b, speed changing 243c, braking 243d, lane changing 243e, dining 243f, drinking 243g, reading 243h, watching movies 243i, etc. For instance, the navigation platform 107 can recommend change(s) of the seats to the safest layout based on the context 117 and the potential negative impact(s) 115, dynamic seat repositioning to create the safest environment, the safest route, the safest activity in the vehicle 101, and/or adapting the guidance/maneuvers of the vehicle 101.

As more autonomous vehicles 101 become more available with increasingly sophisticated features and technologies that support more complicated manipulations, the system 100 can configure and adapt more physical and/or operational vehicle settings other than seat positionings and angles that can improve safety by countering a range of accident impact context. In some embodiments, the seats can also be reconfigured in shape, height, attachments, etc. depending on vehicle capabilities, to mitigate potential accident impact(s). By way of examples, the system 100 can activate more airbags on one side, close some/all windows, adjust safety belt tension(s), prepare for an emergency brake, put a part of the vehicle under a car collision protection mode, etc.

It is noted that although the various embodiments are discussed with respect to accident impact mitigation in autonomous vehicles, it is contemplated that the embodiments are also applicable to non-autonomous or semi-autonomous vehicles. In addition, it is further contemplated that the embodiments are applicable to travel using other modes of transport (e.g., buses, airplanes, subway trains, etc.), or non-vehicular modes of transport such as walking or other pedestrian means.

For instance, alert messages can be presented to riders on subway displays to recommend the safe seating chart based on the route, e.g., left side of a subway train on the current section, then moving to the other side for the next station. As other instances, alter messages can be presented to pedestrians on wearable or carried on person presentation devices 121 such as but not limited to augmented or virtual reality headsets, UEs 123, etc. to render recommendation(s) of walking on a bike lane, moving to the sidewalk closer to the building on the next link (e.g., ice on the sidewalk), etc.

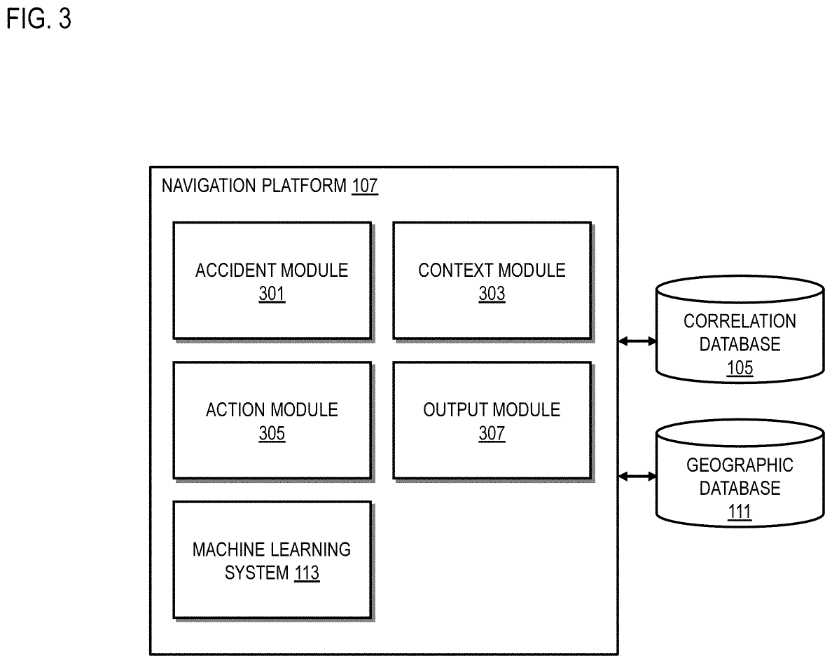

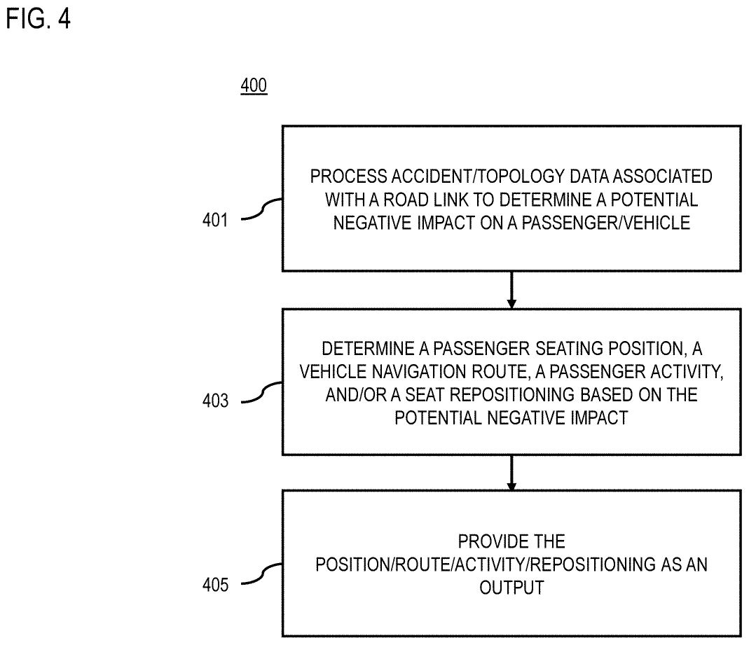

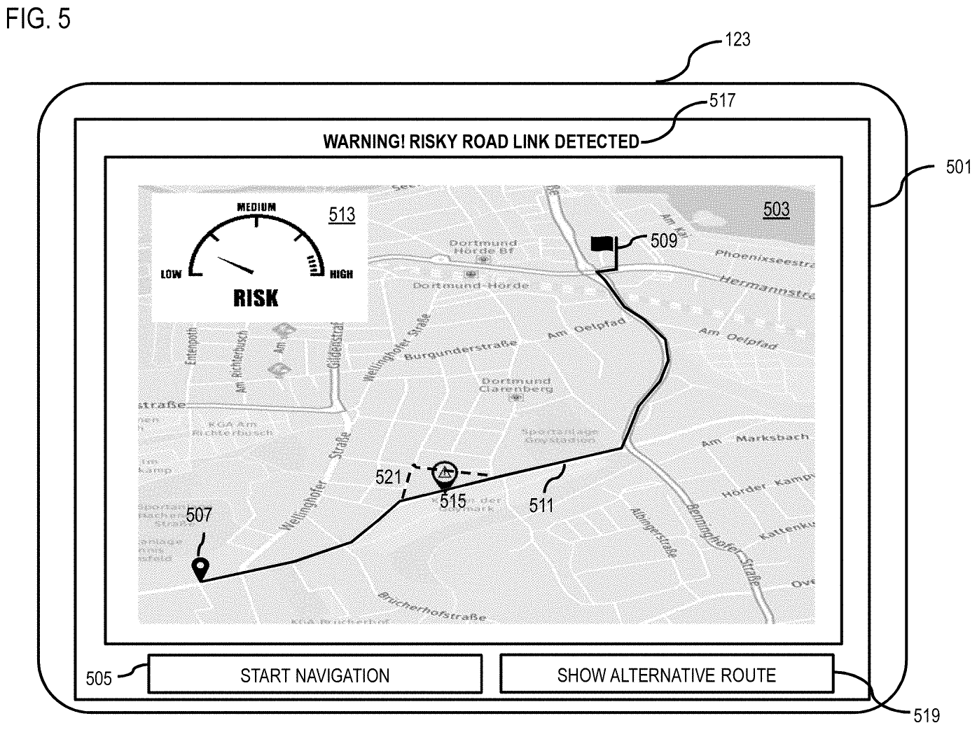

FIG. 3 is a diagram of the components of the navigation platform 107, according to one or more example embodiments. In one embodiment, the navigation platform 107 includes one or more components for minimizing potential vehicle accident impact(s) based on accident/road link correlation and/or contextual data according to the various embodiments described herein. As shown in FIG. 3, the navigation platform 107 includes an accident module 301, a context module 303, an action module 305, an output module 307, and the machine learning system 113 and has connectivity to the accident/road link correlation database 105 and/or the geographic database 111. The above presented modules and components of the navigation platform 107 can be implemented in hardware, firmware, software, or a combination thereof. The above presented modules and components of the navigation platform 107 can be implemented in hardware, firmware, software, or a combination thereof. It is contemplated that the functions of these components may be combined or performed by other components of equivalent functionality. Though depicted as a separate entity in FIG. 1, it is contemplated that the navigation platform 107 may be implemented as a module of any of the components of the system 100 (e.g., a component of the vehicle 101 and/or presentation devices 121). In another embodiment, the navigation platform 107 and/or one or more of the modules 301-307 may be implemented as a cloud-based service, local service, native application, or combination thereof. The functions of the navigation platform 107, the machine learning system 113, and/or the modules 301-307 are discussed with respect to FIGS. 4-5 below.

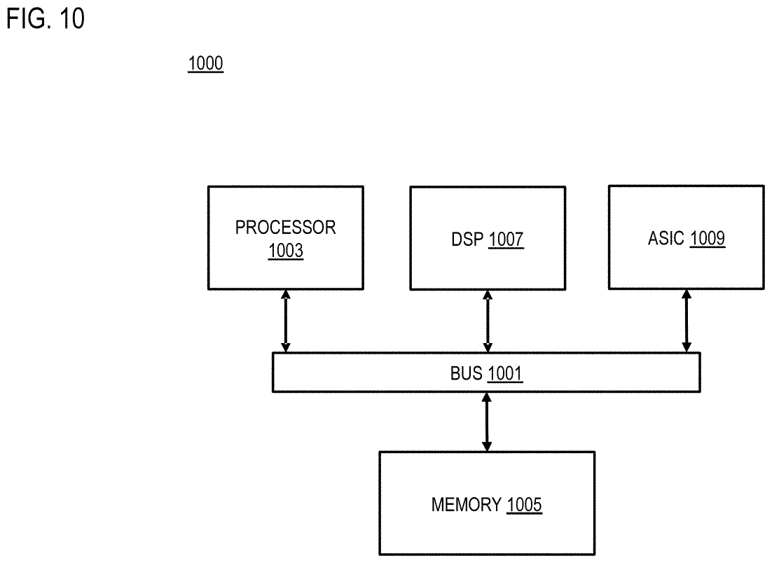

FIG. 4 is a flowchart of a process for minimizing potential vehicle accident impact(s) based on accident/road link correlation and/or contextual data, according to one or more example embodiments. In various embodiments, the navigation platform 107, the machine learning system 113, and/or any of the modules 301-307 may perform one or more portions of the process 400 and may be implemented in, for instance, a chip set including a processor and a memory as shown in FIG. 10. As such, the navigation platform 107 and/or the modules 301-307 can provide means for accomplishing various parts of the process 400, as well as means for accomplishing embodiments of other processes described herein in conjunction with other components of the system 100. The steps of the process 400 can be performed by any feasible entity, such as the navigation platform 107, the modules 301-307, the machine learning system 113, etc. Although the process 400 is illustrated and described as a sequence of steps, it is contemplated that various embodiments of the process 400 may be performed in any order or combination and need not include all the illustrated steps.

In one embodiment, in step 401, the accident module 301 can process accident data, topology data, or a combination thereof associated with a road link (e.g., on a planned route of the vehicle 101) to determine a potential negative impact on a passenger of a vehicle, the vehicle, or a combination thereof resulting from a potential accident on the road link. For instance, the accident data can be generated by map matching one or more accident reports, one or more detected accidents, or a combination thereof to the road link. For instance, the topology data of a road network and/or one or more road links of interest (e.g., geometry, speed limit, etc.) can be retrieved from a database (e.g., the geographic database 111).

In one embodiment, the potential negative impact can include a potential trauma type (e.g., injuries to the back, neck, spine, hip, head, arm, leg, foot, etc.) or level (e.g., degrees 1-5), a potential damage type (e.g., damage description codes such as FC, LBQ, etc.) or level (e.g., a damage severity code 0-7), or a combination thereof. For example, injury severity can be reported by the attending law enforcement officer using a coding scheme for classifying injuries: K—Fatal, A—Incapacitating injury, B—Non-incapacitating injury, C—Possible injury, and O—No injury.

In terms of vehicle damages, the description code “FC” indicates a front-end damage from a concentrated impact, corresponding to the type of impact resulting from a collision with a tree, utility pole, or other narrow object. As another example, the description code “LBQ” indicates a left rear quarter damage (behind the passenger compartment) due to an angular impact by another vehicle or object.

In one embodiment, the context module 303 can use various context data of the context 117 as inputs to the process 400, such as a number of people in the vehicle 101, seat positions and angles related to the seats (e.g., facing directions, etc.), a planned route, passengers information (e.g., medical records, weight, height, etc.), weather conditions (e.g., rain, road/sidewalk dry, temperature, etc.), a water film depth (e.g., for evaluating asphalt pavement drainage), map data, road slope/curvature, a number of lanes/dividers on roads, whether opposite travel is allowed, etc.

In one embodiment, the navigation platform 107 can deploy the machine learning system 113 to build and train an accident impact machine learning model that can determine the potential negative impact(s) 115 for a coming road link. For instance, based on the geometry of the road link and the speed, the navigation platform 107 can predict trauma type and severity. By way of example, a passenger with a neck problem or some other specific conditions is likely to have 5 times more of the collective problems if taking the coming road link.

In one embodiment, in step 403, the action module 305 can determine a seating position within the vehicle for the passenger, a navigation route for the vehicle, an activity for the passenger to perform or avoid while in the vehicle, the dynamic seat repositioning, or a combination thereof based on the potential negative impact. By way of example, the action module 305 can recommend initial seat positioning (e.g., the scenario 221 in FIG. 2B) and/or repositioning dynamically during the ride based on: the vehicle used, a computed route, planned activities by the passengers in the vehicle 101 (e.g., playing games, watching TV, eating, listening to music, daydreaming, writing text messages, eating and drinking, browsing the Internet, calling, using augmented reality (AR) and/or virtual reality (VR) devices, etc.). As another example, the action module 305 can recommend a passenger with motion sickness to lean against a side door when the vehicle 101 is turning at an intersection prone to side collisions.

In one embodiment, the determining of the seating position, the navigation route, the activity for the passenger, the dynamic seat repositioning, or a combination can be updated in real-time based on the potential negative impact. For instance, before approaching a dangerous intersection where the risk mostly comes from the right hand side, the action module 305 can recommend repositioning dynamically (e.g. the scenario 225 in FIG. 2B) based on the initial seat positioning/layout, the passenger context, etc. by moving the seats to the left side and/or by orientating the seats in a way to minimize potential traumas/damages for passengers in the case of an accident.

For instance, the navigation route can be determined based on minimizing the potential negative impact experienced during the navigation route. As another instance, the context module 303 can determine a current activity of the passenger (e.g., dining), and that the activity is not compatible with traveling on the road link based on the potential negative impact. The action module 305 can then determine the navigation route to travel on as an alternate road link (e.g., a longer yet safer road link based on its identified risk) that is compatible with the activity (e.g., dining) based on the trauma data (e.g., injuries by flying forks, spilled coffee, etc.) at collision. By way of example, the alternate road link can be determined based on the number of passenger(s) in the vehicle 101, passenger morphologies (e.g., body size, shape, structure, etc.), passenger desired activities while the vehicle 101 in an autonomous mode, potential accident impact(s) (e.g., risks of traumas) associated to the route links, etc.

In one embodiment, the seating position, the navigation route, the dynamic seat repositioning, or a combination thereof is determined further based on the activity for the passenger to perform (e.g., assuming brace positions) or avoid (e.g., suspending dining, using AR/VR device, etc.) while in the vehicle. For instance, the action module 305 can determine the activity based on e.g., the number of people in the vehicle at that moment, the computed route, the coming road link (e.g., a regular path, an intersection, geometry, slope, etc.), the vehicle used, the type of potential negative impact(s) (e.g., traumas) assigned to the road link on that route, thereby minimizing the potential negative impact experienced while performing the activity and traveling on the road link.

In one embodiment, the action module 305 can adopt a guidance, a maneuver, or a combination thereof of the vehicle 101 while traveling on the road link based on the potential negative impact. For instance, the adoption can be based on the number of people in the vehicle 101, the desired passenger activities to be done while in the vehicle 101, the accident risk(s) and potential negative impact(s) associated with specific route links, etc.

In another embodiment, the seating position, the navigation route, the activity for the passenger, the dynamic seat repositioning, or a combination thereof can be determined further based on a context associated with the passenger, the vehicle, the road link, or a combination thereof. By way of example, the context of the road link can include a water film depth, a curvature, a number of lanes, a presence of a divider, a presence of opposite lane travel, or a combination thereof.

By way of example, the action module 305 can initiate the dynamic seat repositioning based on detecting that the vehicle is approaching the road link within a proximity threshold.

In one embodiment, after passing the road link, the accident module 301 and/or the action module 305 can process sensor data and/or passenger survey data to determine the outcome data of (1) whether the accident actually happened; (2) whether the action(s) 119 was actually taken; and/or (3) whether the potential negative impact(s) 115 was successfully mitigated by taking the action(s) 119. The machine learning system 113 can then use the outcome data to train respective machine learning models (e.g., the accident impact machine learning model, the action machine leaning model, etc.). In addition, the outcome data and/or newly connected correlation data between road link and the accident can be stored in the correlation database 105 for future accident pattern prediction.

In one embodiment, the output module 307 can initiate a presentation of an alert message indicating a risk of the potential negative impact, the potential accident, or a combination thereof. In another embodiment, in step 405, the output module 307 can provide the seating position, the navigation route, the activity for the passenger, a dynamic seat repositioning, or a combination thereof as an output, e.g., to include in the presentation to recommend to passenger(s) and/or to provide to the vehicle 101 for executing actions (e.g., adapt the speed, change to a different lane, etc.).

In another embodiment, the output module 307 can initiate a presentation of a risk heat map indicating risks of potential negative impacts and potential accidents in an area of interest (e.g., a current map area, an area of interest as requested by a passenger, etc.).

In another embodiment, the output module 307 can initiate a presentation of a risk gauge indicating a dynamic risk assessment value of the potential negative impact and/or the potential accident on a current road link. By way of example, the risk gauge can provide a real-time dynamic assessment of the risk for each passenger on her/his seat, which would be based on context attribute(s) and feature parameter(s) of, e.g., the vehicle 101, a road link and the risk associated with the road link, the number of people in the vehicle 101 and their relative positions, activities being performed in the vehicle 101, etc. Some attributes/parameters may be identical for all passengers (e.g., the vehicle 101 and the road link), while some others (e.g., the relative seat positions in the vehicle 101) may vary among passengers. For instance, once a dynamic risk assessment value is computed (e.g., in real-time) for each passenger, the system 100 can make recommendations on how to further reduce the risk by taking specific actions (e.g., change seat positions, angles, change activities, etc.) for different passengers. In one embodiment, the dynamic risk assessment value can be updated every second or at a different frequency based on specific context and/or context change(s) of the context 117 (e.g., speed, FC, environment, weather, passenger movements in the vehicle, etc.).

In one embodiment, a user and or a user group can customize alert messages, such as triggering warnings when continuing a user activity and/or favorite user activities at the coming road link will reach a risk threshold.

FIG. 5 is a diagram of an example user interface (UI) 501 (e.g., of a navigation application) capable of displaying potential accident(s) and/or negative impact(s) during navigation, according to one or more example embodiments. In this example, the UI 501 shown is generated for a UE 123 (e.g., a mobile device, an embedded navigation system, a client terminal, etc.) that includes a map 503, an input 505 of “Start Navigation” between an origin 507 and a destination 509 along a route 511. The UI 501 also shows a risk gauge 513 that monitors a real-time risk assessment value of a current road, which appears to be low and acceptable.

However, the system 100 detects a coming risky road link 515, and shows an alert 517: “Warning! Risky Road Link Detected.” In response to an input 519 of “Show Alternative Route,” the UI 501 presents an alternative route 521.

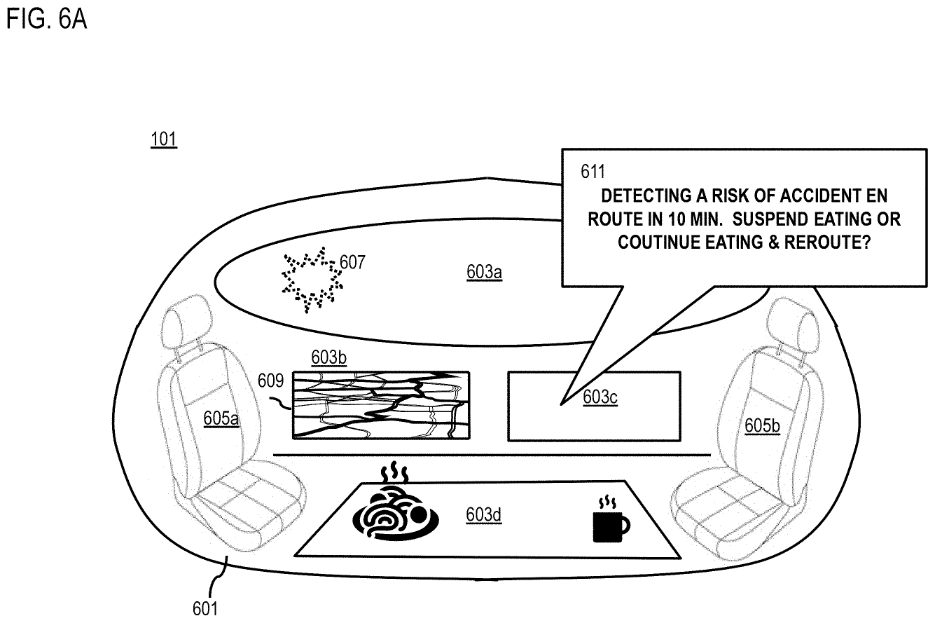

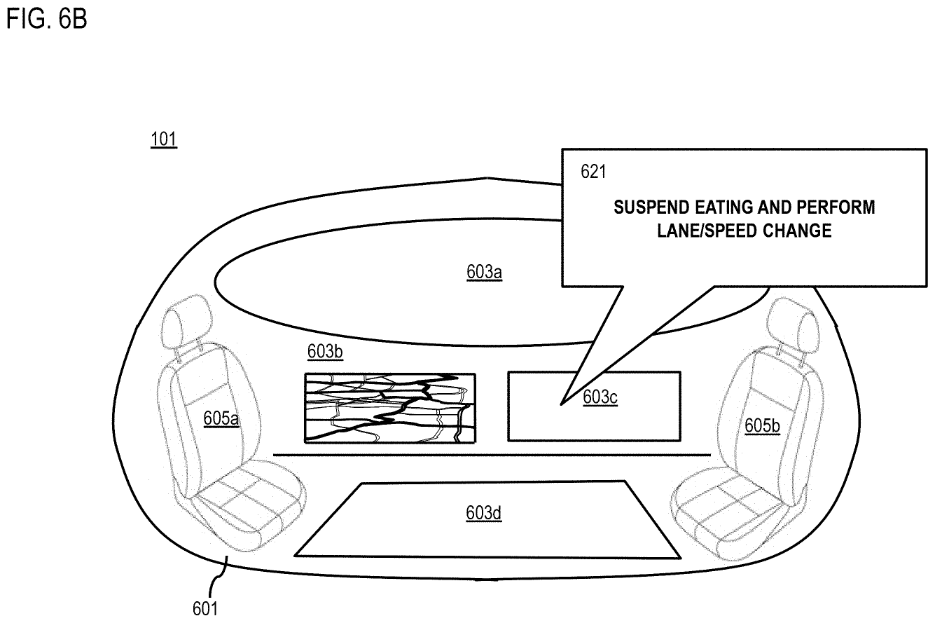

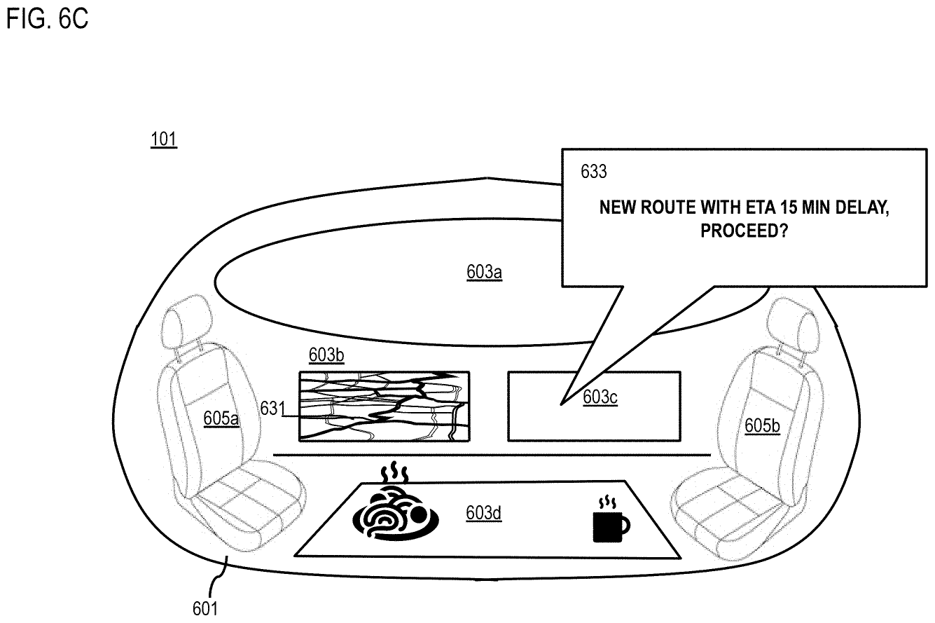

FIGS. 6A-6C are diagrams of example user interfaces built in a vehicle and capable of displaying potential accident(s) and/or negative impact(s) during navigation, according to one or more example embodiments. In the example of FIG. 6A, an autonomous vehicle 101 has a passenger compartment 601 in which several displays 603a-603d (examples of presentation devices 121) are mounted. The displays 603a-603d are of varying sizes and locations with display 603a being a large oval display on a vehicle side wall, displays 603b and 603c being smaller rectangular displays on the vehicle side wall, and display 603d being a large rectangular table. The context module 303 can store data on the dimensions, resolutions, supported media formats, spatial arrangement, etc. of the displays 603a-603d to enable rendering output data, e.g., the potential accident 223, potential negative impact(s) 115 (e.g., passenger trauma, vehicle damage(s), etc.), the alert message indicating a risk of the potential negative impact 115, the risk heat map, the risk gauge, etc. of the process 400 on the displays. In one embodiment, the displays include touch screen(s) that enable user interactions. In another embodiment, the displays can determine or detect one or more actions by a user (e.g., an eye gaze) and automatically confirm the interaction. This is particularly useful in the case of a user's hands being busy with something else.

In FIG. 6A, the output module 307 can separate the output content to be displayed across the displays 603a-603d for passenger(s) seated in either seat 605a or 605b of the passenger compartment 601. In this example, the display 603d is not showing any content but food and drinks are laid on top, the display 603a shows a potential accident 607 using historical image(s), animation(s), virtual reality, augmented reality, etc., the display 603b shows a map 609 of the current route, while the display 603c shows an alert message 611: “Detecting a risk of accident en route in 10 minute. Suspend eating or Continue eating & Reroute?”

In FIG. 6B, the passenger(s) decide to suspend eating and set the food and drinks aside, such that the system 100 has the vehicle 101 continue the planned route yet adjust speed/lane to mitigate potential negative impact(s) associated with the potential accident 607. In this example, the display 603c shows an alert message 621: “Suspend eating and Perform lane/speed change.”

In FIG. 6C, the passenger(s) decide to continue eating and reroute, such that the system 100 can generate the display 603b to show the map 607 with an alternate route 631, and an alert message 633: “New route with an estimate time of arrival (ETA) 15 minute delay, proceed?”

In one embodiment, the navigation platform 107 can process accident data, topology data, or a combination thereof associated with a road link to determine trauma data indicating a potential trauma level to a passenger of a vehicle, the vehicle 101, or a combination thereof resulting from a potential accident on the road link. The navigation platform 107 can store the trauma data in digital map data of a database (e.g., the accident/road link correlation database 105), and provide the digital map data or the database as an output. For instance, the seating position, the navigation route, or a combination can be further based on a number of passengers in the another vehicle.

In another embodiment, the navigation platform 107 can determine a seating position within another vehicle (e.g., one or more neighboring vehicles of the vehicle 101) for another passenger, a navigation route for the another vehicle, or a combination for traveling on the road link based on the trauma data. For instance, the seating position, the navigation route, or a combination thereof can be determined further based on an activity that the another passenger is to perform while in the another vehicle.

In another embodiment, the navigation platform 107 can process accident data, topology data, or a combination thereof associated with a road link to determine trauma data indicating a potential trauma level to a traveler (e.g., vehicle passenger(s), pedestrian(s), etc.) on the road link resulting from a potential accident on the road link. The navigation platform 107 can determine a travel position (e.g., vehicle passenger seat positioning, pedestrian walking positioning (e.g., near a curb, closer to buildings, etc.), a navigation route, an activity, or a combination thereof for the traveler based on the trauma data, and provide the travel position, the navigation route, or a combination thereof as an output.

By way of example, the navigation platform 107 can determine that it is safe for a pedestrian to walk at the current section of a bike lane. As another example, the navigation platform 107 can recommend a pedestrian to move to the sidewalk as close to the building as possible on the next road link to avoid an icy sidewalk surface. As further example, the navigation platform 107 can recommend a pedestrian to cross the next intersection with an accident risk reduced 50% compared to the current intersection, since the next intersection does not have cars turning left onto that street.

In one embodiment, the travel position, the navigation route, or a combination thereof can be determined further based on an activity (e.g., playing an augmented reality mobile game on the sidewalk by several pedestrians) that the traveler is likely to perform. For instance, the travel position, the navigation route, the activity, or a combination can be further based on a number of travelers. By way of example, the navigation platform 107 can recommend the pedestrians to walk across the interaction as a group to guard against potential bicycle crashes.

In another embodiment, the navigation platform 107 can determine that an activity of the traveler is not compatible with traveling on the road link based on the trauma data, and can determine the navigation route to travel on (e.g., an alternate road link) that is compatible with the activity based on the trauma data. By way of example, the navigation platform 107 can recommend the pedestrians to walk across the intersection to look out for potential bicycle crashes without playing the mobile game.

In one embodiment, the machine learning system 113 can build and train an accident impact machine learning model to predict potential accident impacts (e.g., passenger traumas, vehicle damages, etc.) based on inputs such as historical accident impact data, the context 117, etc. For instance, the accident impact machine learning model can extract accident impact classification features and map the features to negative impact categories such as trauma categories: (e.g., injuries to the back, neck, spine, hip, head, arm, leg, foot, etc. in a matrix/table).

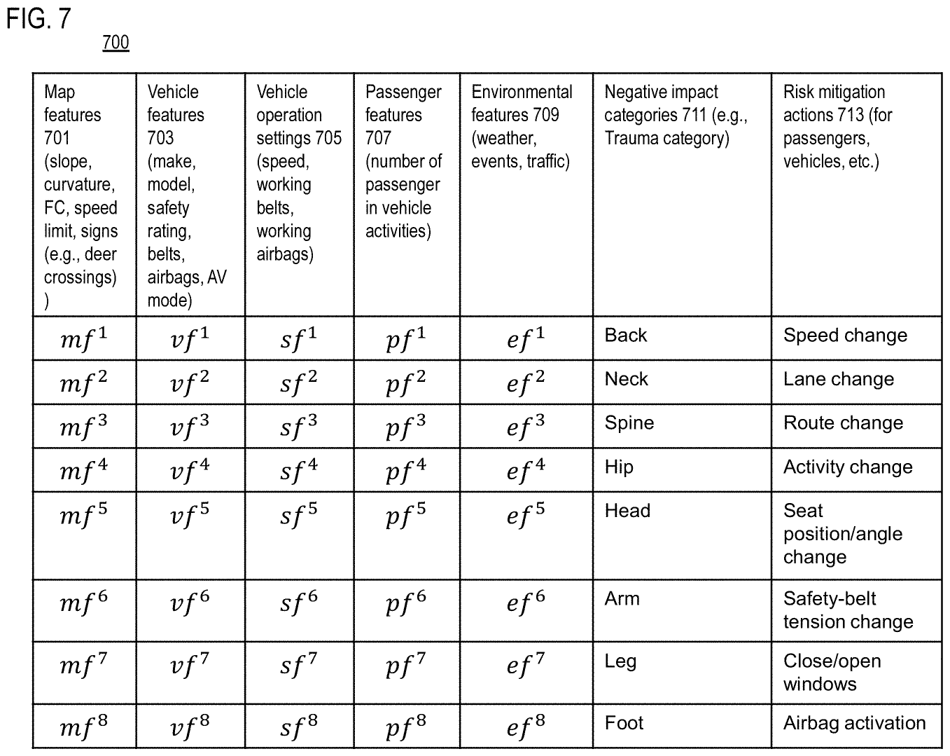

FIG. 7 is a diagram of an example machine learning data matrix, according to one or more example embodiments. In one embodiment, the matrix/table 700 can further include road link feature(s) 701 (e.g., slope, curvature, FC, speed limit, signs (e.g., deer crossings), etc.), vehicle feature(s) 703 (e.g., make, model, characteristics, capabilities-speed range, safety rating, working belts, working airbags, etc.), vehicle operation setting(s) 705 (e.g., speed, AV/manual mode, etc.), passenger features 707 (e.g., ages, medical records, weight, height, pre-existing conditions, a number of passengers, in-vehicle activities, speed preferences, etc.), environment features 709 (e.g., visibility, weather, events, traffic, traffic light status, construction status, etc.), etc., in addition to the negative impact categories 711. For instance, these classification features can be derived from map data, sensor data, context data of the vehicle 101, passenger(s), environment, etc. in the context 117.

By way of example, the matrix/table 700 can list relationships among features and training data. For instance, notation [symbol] mf [symbol] \hat{ }i can indicate the ith set of map features, [symbol] vf [symbol] \hat{ }i can indicate the ith set of vehicle features, [symbol] sf [symbol] \hat{ }i can indicate the ith set of vehicle operation settings, [symbol] pf [symbol] \hat{ }i can indicate the ith set of passenger features, [symbol] ef [symbol] \hat{ }i can indicate the ith set of environmental features, etc.

In one embodiment, the training data can include ground truth data taken from historical accident impact data. For instance, in a data mining process, features are mapped to ground truth trauma to form a training instance. A plurality of training instances can form the training data for the accident impact machine learning model using one or more machine learning algorithms, such as random forest, decision trees, etc. For instance, the training data can be split into a training set and a test set, e.g., at a ratio of 70%:30%. After evaluating several machine learning models based on the training set and the test set, the machine learning model that produces the highest classification accuracy in training and testing can be used as the accident impact machine learning model. In addition, feature selection techniques, such as chi-squared statistic, information gain, gini index, etc., can be used to determine the highest ranked features from the set based on the feature's contribution to classification effectiveness.

In other embodiments, ground truth accident impact data can be more specialized than what is prescribed in the matrix/table 700. For instance, the ground truth could be specific bones or joints that are damaged or different categories of psychological traumas. As another instance, the ground truth further include psychological trauma in addition to or in place of the physical trauma. In the absence of one or more sets of the features 701-709, the model can still make a prediction using the available features.

In one embodiment, the accident impact machine learning model can learn from one or more feedback loops. For example, when an accident index (e.g., a dynamic risk assessment value of the potential negative impact and/or the potential accident on a current road link) is computed/estimated to be very high on a road link yet nobody gets injured any more (e.g., due to the implementation of the process 400), the accident impact machine learning model can learn from the feedback data, via analyzing and reflecting how the high index was generated. The accident impact machine learning model can learn the cause(s), for example, based on the vehicle model, the passenger wearing a body armor, etc., and include new features into the model based on this learning. Alternatively, the accident impact machine learning model can blacklist the road links where the computed index is high but no passenger were injured.

By analogy, the action machine learning model that can determine the action(s) 119 to be taken by the passenger(s) and/or the vehicle 101 prior to or during the road link, based on the context 117 and the potential negative impact(s) 115 can be used for training in a similar way. In one embodiment, the machine learning system 113 selects respective features 701-711 such as road topology, vehicle model, vehicle operation settings, traffic patterns, accident impacts, etc., to determine the optimal action(s) to be taken by the passenger(s), vehicle 101, etc. for different scenarios on different road links. As a result, an additional column can be added in the matrix/table 700 to include risk mitigation actions 713 (for passengers, vehicles, etc.). By way of example, the risk mitigation actions 713 can include speed change, lane change, route change, activity change, seat position/angle change, safety-belt tension change, close/open window, airbag activation, etc.

In other embodiments, the machine learning system 113 can train the accident impact machine learning model and/or the action machine learning model to select or assign respective weights, correlations, relationships, etc. among the features 701-713, to determine optimal action(s) to take for different accident impact scenarios on different road links. In one instance, the machine learning system 113 can continuously provide and/or update the machine learning models (e.g., a support vector machine (SVM), neural network, decision tree, etc.) of the machine learning system 113 during training using, for instance, supervised deep convolution networks or equivalents. In other words, the machine learning system 113 trains the machine learning models using the respective weights of the features to most efficiently select optimal action(s) to take for different accident impact scenarios on different road links.

In another embodiment, the machine learning system 113 of the navigation platform 107 includes a neural network or other machine learning system(s) to update enhanced features on road links. In one embodiment, the neural network of the machine learning system 113 is a traditional convolutional neural network which consists of multiple layers of collections of one or more neurons (which are configured to process a portion of an input data). In one embodiment, the machine learning system 113 also has connectivity or access over the communication network 109 to the accident/road link correlation database 105 and/or the geographic database 123 that can each store map data, the feature data, the outcome data, etc.

In one embodiment, the machine learning system 113 can improve the machine learning models using feedback loops based on, for example, vehicle behavior data and/or feedback data (e.g., from passengers). In one embodiment, the machine learning system 113 can improve the machine learning models using the vehicle behavior data and/or feedback data as training data. For example, the machine learning system 113 can analyze correctly identified accident/impact data and/or action data, missed accident/impact data and/or action data, etc. to determine the performance of the machine learning models.

The above-discussed embodiments can be applied to increase travel safety in any road links including motorways, walkways, bicycle paths, train tracks, airplane runways, etc. to recommend actions to mitigate negative accident impacts thereon.

In one embodiment, the system 100 presents the output data (e.g., the potential accident 223, potential negative impact(s) 115 (e.g., passenger trauma, vehicle damage(s), etc.), the alert message, the risk heat map, the risk gauge, etc. using any interface available on the vehicle 101 including but not limited to an audio interface, and/or a visual interface with a two dimensional (2D), three dimensional (3D), augmented reality, and/or a virtual reality view inside a vehicle, such as on a window (e.g., a vehicle windshield, a heads-up display, etc.) or in a display (e.g., a presentation device built into the vehicle 101 such as an integrated dashboard or headrest display, or a handheld presentation device such as a mobile phone, portable computer, and/or the like).

In one instance, the user interface could also be a headset, goggle, or eyeglass device used separately or in connection with a mobile device. In one embodiment, the system 100 can present or surface the output data in multiple interfaces simultaneously (e.g., presenting a 2D map, a 3D map, an augmented reality view, a virtual reality display, or a combination thereof). In one instance, the system 100 can present the output data through multiple interfaces within the vehicle 101 based on the location or positioning/layout of the passengers (e.g., a windshield for passengers in the front seats and on side windows for passengers in the back seats). In one embodiment, the system 100 could also present the output data to a passenger through other media including but not limited to one or more sounds, haptic feedback, touch, or other sensory interfaces. For example, the system 100 could present the output data through the speakers of the vehicle 101. By way of example, the system 100 can move a car seat relative to presented output data to more accurately simulate or recreate the potential accident in the vehicle 101.

In one embodiment, the system 100 can collect the sensor data, contextual data, or a combination through one or more sensors such as camera sensors, light sensors, LiDAR sensors, radar, infrared sensors, thermal sensors, and the like, to determine the type/kind of the non-driving activities of passengers.

In one embodiment, the presentation devices 121 or navigation platform 107 may provide interactive user interfaces for the output data. In this way, the output data can be interactive content that responds to user interactions through the user interface. For example, the user interface can present an interactive user interface element or a physical controller such as but not limited to a knob or roller ball-based interface, a pressure sensor on a screen or window whose intensity reflects the movement of time, an interface that enables gestures/touch interaction, an interface that enables voice commands, pedals or paddles of the autonomous vehicle (e.g., the vehicle 101), or a combination thereof. In one embodiment, the system 100 and the user interface element, e.g., a joystick, enable a passenger to provide feedback for the effectiveness of the presented output data.

As shown in FIG. 1, the system 100 comprises one or more vehicles 101 configured with one or more sensors 103, and one or more presentation devices 121 (e.g., UEs 123) having connectivity to the navigation platform 107 via the communication network 109. In one embodiment, the vehicles 101 are autonomous vehicles or highly assisted driving vehicles that can sense their environments and navigate within a travel network without driver or occupant input. Although the vehicles 101 are depicted as automobiles, it is contemplated the vehicle 101 may be any type of transportation wherein a passenger is not in control of the vehicle's operation (e.g., an airplane, a drone, a train, a ferry, etc.). In one embodiment, the vehicle sensors 103 (e.g., camera sensors, light sensors, LiDAR sensors, radar, infrared sensors, thermal sensors, and the like) acquire map data and/or sensor data during operation of the vehicle 101 within the travel network for routing, historical mobility data collection, and/or destination prediction.

In one embodiment, the presentation devices 121 or UEs 123 can be associated with any of the types of vehicles or a person or thing traveling within the travel network. By way of example, the presentation device 121 or UEs 123 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that the presentation device 121 or UEs 123 can support any type of interface to the user (such as “wearable” circuitry, etc.). In one embodiment, the vehicles 101 may have cellular or wireless fidelity (Wi-Fi) connection either through the inbuilt communication equipment or from the UEs 123 associated with the vehicles 101. Also, the UEs 123 may be configured to access the communication network 109 by way of any known or still developing communication protocols.

In one embodiment, the UEs 123 include a user interface element configured to receive a user input (e.g., a knob, a joystick, a rollerball or trackball-based interface, a touch screen, etc.). In one embodiment, the user interface element could also include a pressure sensor on a screen or a window (e.g., a windshield of a vehicle 101, a heads-up display, etc.), an interface element that enables gestures/touch interaction by a user, an interface element that enables voice commands by a user, or a combination thereof. In one embodiment, the UEs 123 may be configured with various sensors 125 for collecting passenger sensor data and/or context data during operation of the vehicle 101 along one or more roads within the travel network. By way of example, the sensors 125 are any type of sensor that can detect a passenger's gaze, heartrate, sweat rate or perspiration level, eye movement, body movement, or combination thereof, in order to determine a passenger context or a response to output data.

In one embodiment, the navigation platform 107 has connectivity over the communication network 109 to the services platform 129 that provides the services 131. By way of example, the services 131 may also be other third-party services and include mapping services, navigation services, travel planning services, notification services, social networking services, content (e.g., audio, video, images, etc.) provisioning services, application services, storage services, contextual information determination services, location-based services, information-based services (e.g., weather, news, etc.), etc.

In one embodiment, the content providers 133 may provide content or data (e.g., including geographic data, output data, historical mobility data, etc.). The content provided may be any type of content, such as map content, output data, audio content, video content, image content, etc. In one embodiment, the content providers 133 may also store content associated with the accident/road link correlation database 105, the geographic database 111, navigation platform 107, services platform 129, services 131, and/or vehicles 101. In another embodiment, the content providers 133 may manage access to a central repository of data, and offer a consistent, standard interface to data, such as a repository of accident/road link correlation database 105 and/or the geographic database 111.

By way of example, as previously stated the vehicle sensors 103 may be any type of sensor. In certain embodiments, the vehicle sensors 103 may include, for example, a global positioning sensor for gathering location data, a network detection sensor for detecting wireless signals or receivers for different short-range communications (e.g., Bluetooth, Wi-Fi, light fidelity (Li-Fi), near field communication (NFC) etc.), temporal information sensors, a camera/imaging sensor for gathering image data (e.g., for detecting objects proximate to the vehicle 101), an audio recorder for gathering audio data (e.g., detecting nearby humans or animals via acoustic signatures such as voices or animal noises), velocity sensors, and the like. In another embodiment, the vehicle sensors 103 may include sensors (e.g., mounted along a perimeter of the vehicle 101) to detect the relative distance of the vehicle 101 from lanes or roadways, the presence of other vehicles, pedestrians, animals, traffic lights, road features (e.g., curves) and any other objects, or a combination thereof. In one scenario, the vehicle sensors 103 may detect weather data, traffic information, or a combination thereof. In one example embodiment, the vehicles 101 may include GPS receivers to obtain geographic coordinates from satellites 135 for determining current location and time. Further, the location can be determined by a triangulation system such as A-GPS, Cell of Origin, or other location extrapolation technologies when cellular or network signals are available. In another example embodiment, the one or more vehicle sensors 103 may provide in-vehicle navigation services.

The communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the navigation platform 107 may be a platform with multiple interconnected components. By way of example, the navigation platform 107 may include multiple servers, intelligent networking devices, computing devices, components, and corresponding software for determining upcoming vehicle events for one or more locations based, at least in part, on signage information. In addition, it is noted that the navigation platform 107 may be a separate entity of the system 100, a part of the services platform 129, the one or more services 131, or the content providers 133.

By way of example, the vehicles 101, the UEs 123, the navigation platform 107, the services platform 129, and the content providers 133 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

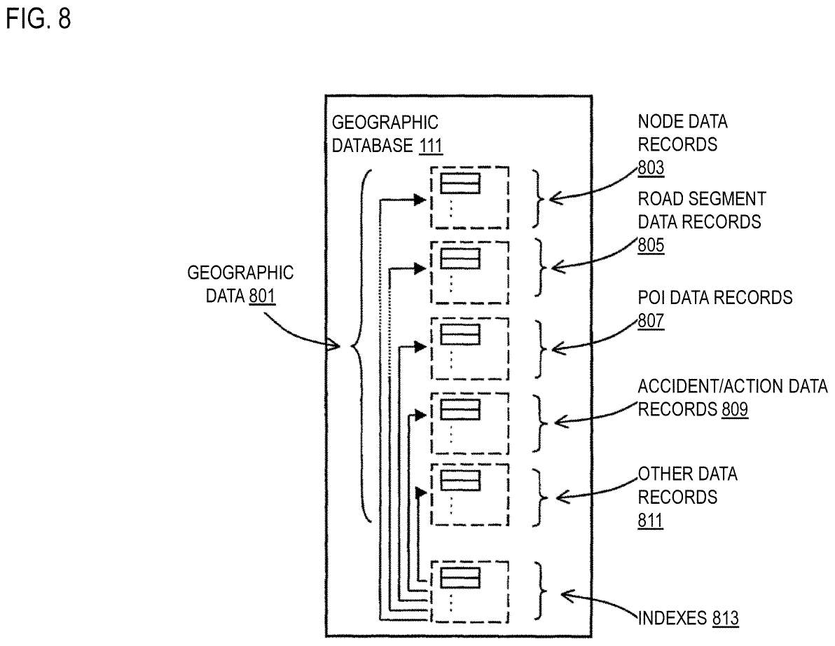

FIG. 8 is a diagram of a geographic database 111 capable of storing map data for dynamic population density predictions, according to one or more example embodiments. In one embodiment, the geographic database 111 includes geographic data 801 used for (or configured to be compiled to be used for) mapping and/or navigation-related services.

In one embodiment, geographic features (e.g., two-dimensional, or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 111.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 111 follows certain conventions. For example, links do not cross themselves and do not cross each other except at a node. Also, there are no duplicated shape points, nodes, or links. Two links that connect each other have a common node. In the geographic database 111, overlapping geographic features are represented by overlapping polygons. When polygons overlap, the boundary of one polygon crosses the boundary of the other polygon. In the geographic database 111, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic data 801 of the geographic database 111 includes node data records 803, road segment or link data records 805, POI data records 807, accident/action data records 809, other data records 811, and indexes 813, for example. More, fewer, or different data records can be provided. In one embodiment, additional data records (not shown) can include cartographic (“carto”) data records, routing data, and maneuver data. In one embodiment, the indexes 813 may improve the speed of data retrieval operations in the geographic database 111. In one embodiment, the indexes 813 may be used to quickly locate data without having to search every row in the geographic database 111 every time it is accessed. For example, in one embodiment, the indexes 813 can be a spatial index of the polygon points associated with stored feature polygons.

In exemplary embodiments, the road segment data records 805 are links or segments representing roads, streets, or paths, as can be used in the calculated route or recorded route information for determination of one or more personalized routes. The node data records 803 are end points corresponding to the respective links or segments of the road segment data records 805. The road link data records 805 and the node data records 803 represent a road network, such as used by vehicles, cars, and/or other entities. In addition, the geographic database 111 can contain path segment and node data records or other data that represent 3D paths around 3D map features (e.g., terrain features, buildings, other structures, etc.) that occur above street level, such as when routing or representing flightpaths of aerial vehicles 101 (e.g., drones), for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 807. The geographic database 111 can also include data about places, such as cities, towns, or other communities, and other geographic features, such as bodies of water, mountain ranges, etc. Such place or feature data can be part of the POI data records 807 or can be associated with POIs or POI data records 807 (such as a data point used for displaying or representing a position of a city).

In one embodiment, the geographic database 111 can also include accident/action data records 809 that can include the outcome data of actual accident(s)/action(s), the output data of the process 400 (e.g., the potential accident 223, potential negative impact(s) 115, an alert message indicating a risk of the potential negative impact 115, the risk heat map, the risk gauge, etc.), etc., for minimizing potential vehicle accident impacts based on accident/road link correlation and/or contextual data according to the embodiment described herein. In one embodiment, the accident/action data records 809 can be associated with one or more of the node records 803, road segment records 805, and/or POI data records 807 so that the output data can inherit characteristics, properties, metadata, etc. of the associated records (e.g., location, address, POI type, etc.) of the corresponding destination or POI at selected destinations.

In one embodiment, the geographic database 111 can be maintained by the services platform 129 and/or any of the services 131 of the services platform 129 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ aerial drones (e.g., using the embodiments of the privacy-routing process described herein) or field vehicles 101 (e.g., mapping drones or vehicles equipped with mapping sensor arrays, e.g., LiDAR) to travel along roads and/or within buildings/structures throughout the geographic region to observe features and/or record information about them, for example. Also, remote sensing, such as aerial or satellite photography or other sensor data, can be used.

The geographic database 111 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation capable device or vehicle. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for minimizing potential vehicle accident impact(s) based on accident/road link correlation and/or contextual data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

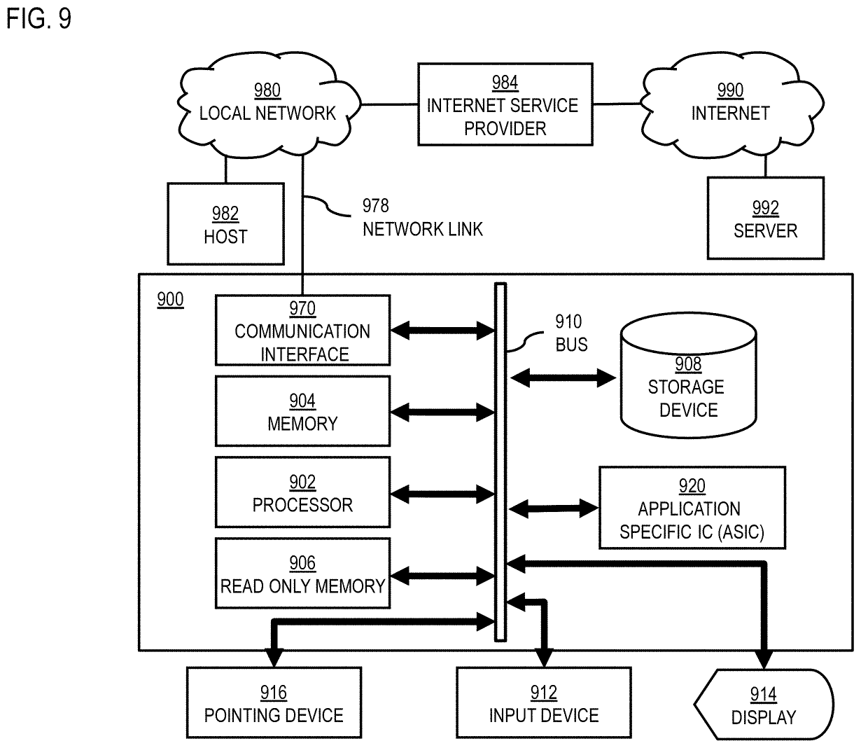

FIG. 9 illustrates a computer system 900 upon which an embodiment of the invention may be implemented. Computer system 900 is programmed (e.g., via computer program code or instructions) to minimize potential vehicle accident impact(s) based on accident/road link correlation and/or contextual data as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to minimizing potential vehicle accident impact(s) based on accident/road link correlation and/or contextual data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. The processors 902 may be implemented as mechanical, electrical, magnetic, optical, chemical or quantum components, among others, alone or in combination.

Computer system 900 also includes a memory 904 coupled to bus 910. The memory 904, such as a random access memory (RANI) or other dynamic storage device, stores information including processor instructions for minimizing potential vehicle accident impact(s) based on accident/road link correlation and/or contextual data. Dynamic memory allows information stored therein to be changed by the computer system 900. RANI allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk, or flash card, for storing information, including instructions, that persists even when the computer system 900 is turned off or otherwise loses power.

Information, including instructions for minimizing potential vehicle accident impact(s) based on accident/road link correlation and/or contextual data, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners, and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic, or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 109 for minimizing potential vehicle accident impact(s) based on accident/road link correlation and/or contextual data.

The term computer-readable medium is used herein to refer to any medium that participates in providing information to processor 902, including instructions for execution. Such a medium may take many forms, including, but not limited to, non-volatile media, volatile media, and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 10 illustrates a chip set 1000 upon which an embodiment of the invention may be implemented. Chip set 1000 is programmed to minimize potential vehicle accident impact(s) based on accident/road link correlation and/or contextual data as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to minimize potential vehicle accident impact(s) based on accident/road link correlation and/or contextual data. The memory 1005 also stores the data associated with or generated by the execution of the inventive steps.

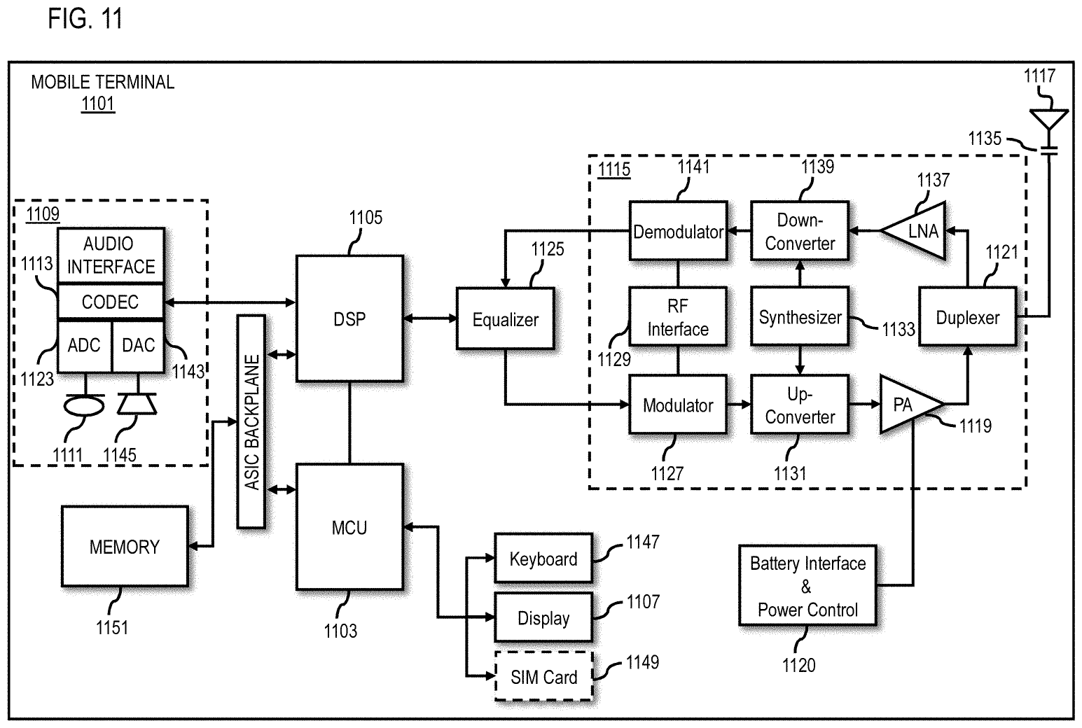

FIG. 11 is a diagram of exemplary components of a mobile terminal 1101 (e.g., a presentation device 121 such as a UE 123 or part thereof) capable of operating in the system of FIG. 1, according to one or more example embodiments. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to minimize potential vehicle accident impact(s) based on accident/road link correlation and/or contextual data. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the mobile station 1101. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1151 may be, but not limited to, a single memory, CD, DVD, ROM, RAM, EEPROM, optical storage, or any other non-volatile or non-transitory storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
processing accident data, topology data, or a combination thereof associated with a road link to determine a potential negative impact on a passenger of a vehicle, the vehicle, or a combination thereof resulting from a potential accident on the road link;
determining a seating position within the vehicle for the passenger, a navigation route for the vehicle, an activity for the passenger to perform or avoid while in the vehicle, a dynamic seat repositioning, or a combination thereof based on the potential negative impact; and
providing the seating position, the navigation route, the activity for the passenger, the dynamic seat repositioning, or a combination thereof as an output.

2. The method of claim 1, wherein the potential negative impact includes a potential trauma type or level, a potential damage type or level, or a combination thereof.

3. The method of claim 1, wherein the seating position, the navigation route, the dynamic seat repositioning, or a combination thereof is determined further based on the activity for the passenger to perform or avoid while in the vehicle.

4. The method of claim 1, further comprising:
determining that an activity of the passenger is not compatible with traveling on the road link based on the potential negative impact; and
determining the navigation route to travel on an alternate road link that is compatible with the activity based on the trauma data.

5. The method of claim 1, further comprising:
initiating a presentation of an alert message indicating a risk of the potential negative impact, the potential accident, or a combination thereof.

6. The method of claim 1, further comprising:
initiating the dynamic seat repositioning based on detecting that the vehicle is approaching the road link within a proximity threshold.

7. The method of claim 1, wherein the navigation route is determined based on minimizing the potential negative impact experienced during the navigation route.

8. The method of claim 1, further comprising:
determining the activity based on minimizing the potential negative impact experienced while performing the activity and traveling on the road link.

9. The method of claim 1, further comprising:
adapting a guidance, a maneuver, or a combination thereof of the vehicle while traveling on the road link based on the potential negative impact.

10. The method of claim 1, wherein the seating position, the navigation route, the activity for the passenger, the dynamic seat repositioning, or a combination thereof is determined further based on a context associated with the passenger, the vehicle, the road link, or a combination thereof; and wherein the context of the road link includes a water film depth, a curvature, a number of lanes, a presence of a divider, a presence of opposite lane travel, or a combination thereof.

11. The method of claim 1, wherein the determining of the seating position, the navigation route, the activity for the passenger, the dynamic seat repositioning, or a combination is updated in real-time based on the potential negative impact.

12. The method of claim 1, wherein the accident data is generated by map matching one or more accident reports, one or more detected accidents, or a combination thereof to the road link.

13. An apparatus comprising:
at least one processor; and
at least one memory including computer program code for one or more programs,
the at least one memory and the computer program code configured to, with the at least one processor, cause the apparatus to perform at least the following:
process accident data, topology data, or a combination thereof associated with a road link to determine trauma data indicating a potential trauma level to a passenger of a vehicle, the vehicle, or a combination thereof resulting from a potential accident on the road link;
store the trauma data in digital map data of a geographic database; and
provide the digital map data or the geographic database as an output.

14. The apparatus of claim 13, wherein the apparatus is further caused to:
determine a seating position within another vehicle for another passenger, a navigation route for the another vehicle, or a combination for traveling on the road link based on the trauma data.

15. The apparatus of claim 13, wherein the seating position, the navigation route, or a combination thereof is determined further based on an activity that the another passenger is to perform while in the another vehicle.

16. The apparatus of claim 13, wherein the seating position, the navigation route, or a combination is further based on a number of passengers in the another vehicle.

17. A non-transitory computer readable storage medium including one or more sequences of one or more instructions which, when executed by one or more processors, cause an apparatus to at least perform:
processing accident data, topology data, or a combination thereof associated with a road link to determine trauma data indicating a potential trauma level to a traveler on the road link resulting from a potential accident on the road link;
determining a travel position, a navigation route, an activity, or a combination thereof for the traveler based on the trauma data; and
providing the travel position, the navigation route, or a combination thereof as an output.

18. The non-transitory computer readable storage medium of claim 17, wherein the travel position, the navigation route, or a combination thereof is determined further based on an activity that the traveler is to perform.

19. The non-transitory computer readable storage medium of claim 17, wherein the travel position, the navigation route, the activity, or a combination is further based on a number of travelers.

20. The non-transitory computer readable storage medium of claim 17, wherein the apparatus is caused to further perform:
determining that an activity of the traveler is not compatible with traveling on the road link based on the trauma data; and
determining the navigation route to travel on an alternate road link that is compatible with the activity based on the trauma data.
